(19) United States
(12) Patent Application Publication
(10) Pub. No.: US 2012/0077116 A1
(43) Pub. Date: Mar. 29, 2012

(54) ELECTROPHOTOGRAPHIC PHOTORECEPTOR AND IMAGE FORMING APPARATUS

(75) Inventors: Shinichi HAMAGUCHI, Tokyo (JP); Tomoo SAKIMURA, Tokyo (JP); Mayuko MATSUSAKI, Tokyo (JP)

(73) Assignee: KONICA MINOLTA BUSINESS TECHNOLOGIES, INC., Tokyo (JP)

(21) Appl. No.: 13/238,760

(22) Filed: Sep. 21, 2011

(30) Foreign Application Priority Data
Sep. 28, 2010 (JP) 2010-216679

(51) Int. Cl. G03G 15/00

(52) U.S. Cl. 430/56; 399/159; 430/57.1

(57) ABSTRACT

An organic photoreceptor comprising a cylindrical support having thereon at least a charge generation layer and a charge transport layer, the cylindrical support having a corrugation processing profile along a central axis direction of the cylindrical support provided on a circumferential surface of the cylindrical support, wherein the corrugation processing profile meets Formula 1:

10 μm≦ΔL, Formula 1

provided that ΔL represents a maximum value of variation of periods of the corrugation processing profile within an image-forming region of the cylindrical support, and the charge generation layer comprises a gallium phthalocyanine pigment.

This application is based on Japanese Patent Application No. 2010-216679 filed on Sep. 28, 2010 in Japanese Patent Office, the entire content of which is hereby incorporated by reference.

### TECHNICAL FIELD

The present invention relates to an electrophotographic photoreceptor (also referred to simply as a photoreceptor) and an image forming apparatus applicable for forming an image having very high image quality in such as the light printing field.

### BACKGROUND OF THE INVENTION

In recent years, the quality of images formed by a printing system employing a dry electrophotographic system has been improved, and such a printing system has come to be employed in a printing field of comparatively small number print copies. As the result, the desired image level has been further raised, and rare usage in the past, for example, printing onto a coated paper sheet, printing for high coverage images and printing a large amount of high quality images, has become a heavy usage. Accompanying with this, generation of problems which have not been mentioned so far has become increased.

As one of such problems, there is cited a problem of generation of interferential streaks in a halftone image seemingly originated by a light exposure pattern and a cutting frequency on the support surface of a photoreceptor. This is a problem which has frequently occurred in recent years due to a combination of, for example, a demand to improve evenness of an intermediate color; improvement in the performance of image forming apparatuses and usage of coated paper sheets, and has not been able to be handled by the conventional art.

So far this problem has been responded by devising the corrugation profile on the support surface of a photoreceptor (for example, refer to Patent Documents 1-3). Each of these techniques disclosed therein provides a certain effect as a countermeasure to the interferential streaks which have been deemed to be a problem. However, a new problem has arisen, in which, when a high quality image is formed on a coated paper sheet with a photoreceptor having a support surface exhibiting a corrugation profile according to the countermeasure, streaks due to the corrugation profile appear more clearly on the image.

Also, in an electrophotographic image obtained by using a coated paper sheet, a high quality image exhibiting higher gradation compared with an electrophotographic image formed on an ordinary paper sheet can be obtained. However, a new problem has arisen, in which, unevenness in tone tends to occur when a photoreceptor having a support surface exhibiting a corrugation profile is used.

Namely, the formation of the corrugation profile on a photoreceptor surface has been sufficiently effective for an image quality level of an image formed on a plain paper sheet, which has conventionally been main current in offices. However, in the case of high quality images (for example, formed onto a coated paper sheet in the light printing field) whose demand has become increased in recent years, a new image defect originated from the corrugation profile is observed.
(Patent Document 1) Japanese Patent No. 3480618
(Patent Document 2) Japanese Patent Application Publication Open to Public Inspection (hereafter referred to as JP-A) No. 2003-91085
(Patent Document 3) Japanese Patent No. 3894023

### SUMMARY OF THE INVENTION

In view of the foregoing problems, the present invention was achieved. An object of the present invention is to provide an organic photoreceptor which enables providing high quality and high gradation electrophotographic images by avoiding image defects such as occurrence of black spots, unevenness in gradation, and a streak-like image defect which often occurs in a high quality and high gradation electrophotographic image obtained by, for example, forming an electrophotographic image on a coated paper sheet, as well as to provide an image forming apparatus employing said organic photoreceptor.

One of the aspects to achieve the above object of the present invention is an organic photoreceptor comprising a cylindrical support having thereon at least a charge generation layer and a charge transport layer, the cylindrical support having a corrugation processing profile along a central axis direction of the cylindrical support provided on a circumferential surface of the cylindrical support, wherein

the corrugation processing profile meets Formula 1:

10 μm≦ΔL, Formula 1

provided that ΔL represents a maximum value of variation of periods of the corrugation processing profile within an image-forming region of the cylindrical support, and

the charge generation layer comprises a gallium phthalocyanine pigment.

### BRIEF DESCRIPTION OF THE DRAWINGS

FIG. 1 is a diagram showing streak-shaped density unevenness appearing on the final picture plane as a problem to be solved in the present invention.

FIG. 2 is a schematic diagram showing film thickness variation of a charge generating layer caused by cutting pitch on the surface of a conductive support.

FIG. 3 indicates how to determine ΔL via measured data in the present invention.

FIG. 4 is a schematic diagram showing an example of a color image forming apparatus equipped with an electrophotographic photoreceptor of the present invention.

FIG. 5 illustrates explanatory drawings showing half-tone exposure patterns.

### DESCRIPTION OF THE PREFERRED EMBODIMENTS

The present inventors have found that the easy appearance of the periodical corrugation profile formed on the support surface of the photoreceptor via tool bit cutting process as the aforementioned image defect relates also to the charge generating material as well as to the periodical profile formed on the support surface of the photoreceptor. Thus, the present invention was achieved.

Namely, when a processing to disrupt the periodicity on the support is conducted to avoid the streak defect, the relative speed between the crude cylindrical support to be machined and the tool bit is changed. Accordingly, it was found that, when the relative speed is increased, minute exfoliation or burr tends to occur on the cylindrical support, and such exfoliation or burr results in occurrence of a point defect in the image originated from such defect on the cylindrical support, specifically under a high temperature-high humidity condition. In order to avoid this problem, it was found that a pigment exhibiting a smaller variation in sensitivity when the thickness of the charge generating layer is varied is effective as a charge generating material, while the pigment exhibits a high sensitivity. Thus, the present invention was achieved.

Namely, the above object of the present invention is achieved by the following structures.

(1) An organic photoreceptor comprising a cylindrical support having thereon at least a charge generation layer and a charge transport layer, the cylindrical support having a corrugation processing profile along a central axis direction of the cylindrical support provided on a circumferential surface of the cylindrical support,
wherein

the corrugation processing profile meets Formula 1:

10 μm≦ΔL, Formula 1

provided that ΔL represents a maximum value of variation of periods of the corrugation processing profile within an image-forming region of the cylindrical support, and

the charge generation layer comprises a gallium phthalocyanine pigment.

(2) The organic photoreceptor of Item (1), wherein the gallium phthalocyanine pigment is a chlorogallium phatalocyanine having specific diffraction peaks at Bragg angles (2θ±0.2°) of at least 7.4°, 16.6°, 25.5° and 28.3° in an X-ray diffraction spectrum using Cu—Kα radiation.
(3) The organic photoreceptor of Item (1), wherein the gallium phthalocyanine pigment is a hydroxygallium phatalocyanine having specific diffraction peaks at Bragg angles (2θ±0.2°) of at least 7.5°, 9.9°, 12.5°, 16.3°, 18.6°, 25.1° and 28.1° in an X-ray diffraction spectrum using Cu—Kα radiation.
(4) The organic photoreceptor of any one of Items (1) to (3) having an intermediate layer between the cylindrical support and the charge generation layer.
(5) The organic photoreceptor of Item (4), wherein the intermediate layer comprises particles.
(6) The organic photoreceptor of any one of Items (1) to (5), wherein the corrugation processing profile meets

10 μm≦ΔL≦200 μm.

(7) The organic photoreceptor of any one of Items (1) to (5), wherein the corrugation processing profile meets

10 μm≦ΔL≦100 μm.

(8) An image forming apparatus comprising:
the organic photoreceptor of any one of Items (1) to (7);
a device to form a latent image on the organic photoreceptor,
a device to develop the latent image with a toner,
a device to transfer a toner image formed on the organic photoreceptor to
an image support; and
a device to fix the toner image after transferred.

By using the photoreceptor of the present invention, there is provided an organic photoreceptor which enables providing high quality and high gradation electrophotographic images by avoiding image defects such as occurrence of black spots, unevenness in gradation, and a streak-like image defect which often occurs in a high quality and high gradation electrophotographic image obtained by, for example, forming an electrophotographic image on a coated paper sheet, as well as an image forming apparatus employing said organic photoreceptor.

Now, the present invention will further be described.

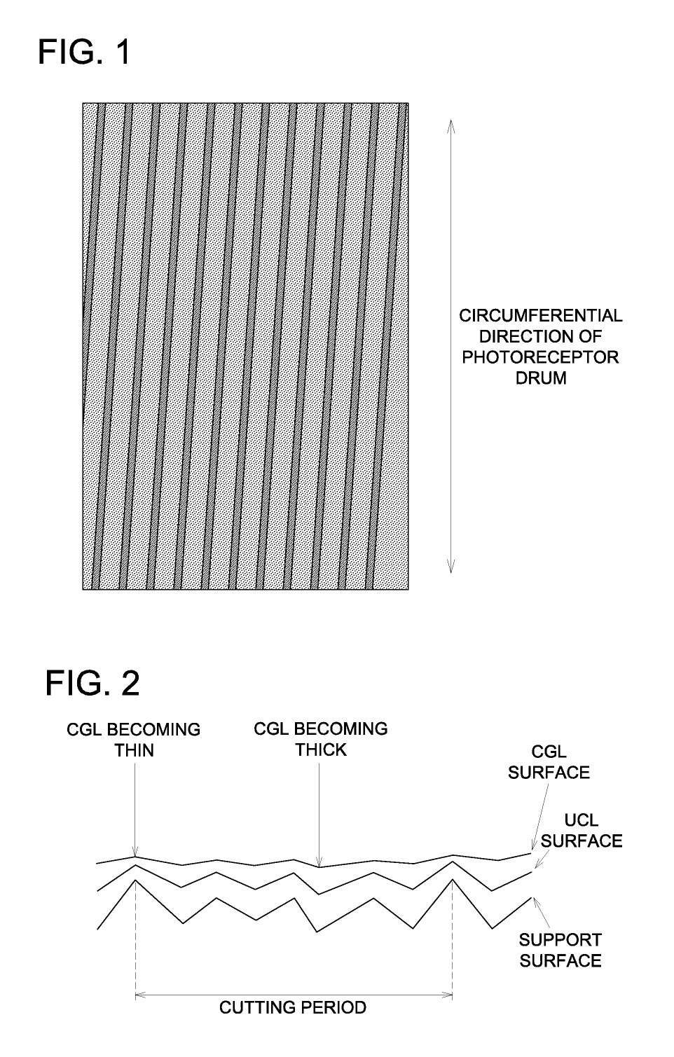

The image defects deemed as a problem in the present invention caused by a phenomenon through which diagonal streak-like unevenness in image density is produced in an image as shown in FIG. 1, and exhibit an eye-catching feature in a uniform image. Specifically, it becomes a problem in a large sized high quality image like in the case of a smooth surface light printing image. Specifically, it becomes a notable problem under a low temperature-low humidity condition.

According to the examination by the inventors, the reason of the occurrence of the interferential streaks which is deemed to be a problem in the present invention is as follows.

Interferential streaks are not originated by a photoreceptor support itself, but produced when the coating amount of a charge generating layer (CGL) coating liquid is periodically varied in response to the surface profile of the support, whereby the film thickness after drying is periodically varied, and the local sensitivity variation exhibits periodicity. That is, when a photoreceptor in which the thickness of the charge generating layer is periodically varied as described in FIG. 2 (accordingly, sensitivity is periodically varied) is periodically exposed to light from a laser light source such as a LED light source, streak-like density unevenness is produced via interference between sensitivity and light exposure, both of which are periodically varied.

As to one of the main points of the present invention, the inventors have found that it is extremely effective for reduction of interferential streaks to vary the periodically formed corrugation widths on the surface of a cylindrical conductive support above a certain level by cutting. Further, it has been found that an excellent image can be obtained by employing a pigment exhibiting an excellent dispersibility and a smaller humidity dependence of the property, even when high quality images are desired. The value of ΔL is preferably 10 μm or more in the present invention, because when the ΔL value is less than 10 μm, image unevenness caused by interference and variation of color tone in the case of color images tends to occur.

The periodical corrugation profile can be formed by conducting cutting processing or nozzle processing (namely, blowing an abrasive agent from the tip of a nozzle) while rotating a cylindrical conductive support.

The method to attain ΔL of 10 μm or more, ΔL being an index for irregularity, is not specifically limited, however, the following examples may be cited. For example, when the support surface is treated by cutting processing, a method to frequently change the cutting periodicity may be cited. This method can be conducted by frequently varying the moving speed of the tool bit against the support surface while processing.

For example, in the case of an CNC lathe in which tool bit moving speed Xₙ (mm/revolution) and ordering location Yₙ (mm) are ordered, carried out is a program of n blocks composed of (X₁, Y₁), (X₂, Y₂), - - - (Xₙ, Yₙ). When the value of (Yₘ₊₁−Yₘ)/Xₘ is not an integer in the m^{th} block, for example, the tool bit moving speed is reduced in order to switch the moving speed of the tool bit at the endpoint of the m^{th} block, whereby the speed is increased to ordering speed Xₘ₊₁ in the next (m+1)^{th} block. Thus, the moving speed of the tool bit can be varied. Even when the same program is used, the value of ΔL may become different when the rotation speed of the main shaft of the lathe is varied. This would be because the judgment to switch the moving speed of the tool bit, which is carried out based on the observation of the movement of the tool bit, is carried out intermittently, of which interval is not sufficiently short. Namely, the value of ΔL depends on: the design of the lathe; the values of above X and Y; and the rotation speed of the main shaft of the lathe.

When using not a CNC lathe but an analog lathe, it is possible to change a tool bit moving speed by outputting a motor voltage to control the tool bit moving speed through a plural resistance-switching circuit. Further, for example, it is also possible to change the tool bit moving speed employing a power supply by which voltage of a prescribed waveform can be output. Further, ΔL of 10 μm or more may also be attained by appropriately varying the rotation speed of the cylindrical conductive support while processing, which may be conducted in the same manner as the above described method for an analog lathe.

The value of ΔL tends to become larger when the rotation speed of the cylindrical conductive support become larger in both the cases of an CNC lathe and an analog lathe.

In the case where an intermediate layer (UCL) is provided on the cylindrical conductive support and a charge generation layer is provided on the intermediate layer, the underlying surface profile means a surface profile of the intermediate layer, and it is mainly determined by the surface profile of the cylindrical conductive support and the composition of the intermediate layer (FIG. 2 illustrating this case).

As described above, it would appear that it is effective for the reduction of interferential streaks of the present invention to reduce the periodicity of the charge generating layer thickness of the photoreceptor, and in order to realize this, it is effective to reduce the periodicity of the corrugation profile in the main scanning direction of the photoreceptor support. It is also effective to utilize an intermediate layer coating particles, since such an intermediate layer has a random corrugation shaped surface originated from the particles, by which the periodicity of the cylindrical conductive support is reduced, whereby the interferential streaks can be reduced. As described above, the ΔL value is preferably 10 μm or more. The ΔL value is more preferably 10 μm-200 μm and further more preferably 10 μm-100 μm.

### (Measuring Method of ΔL)

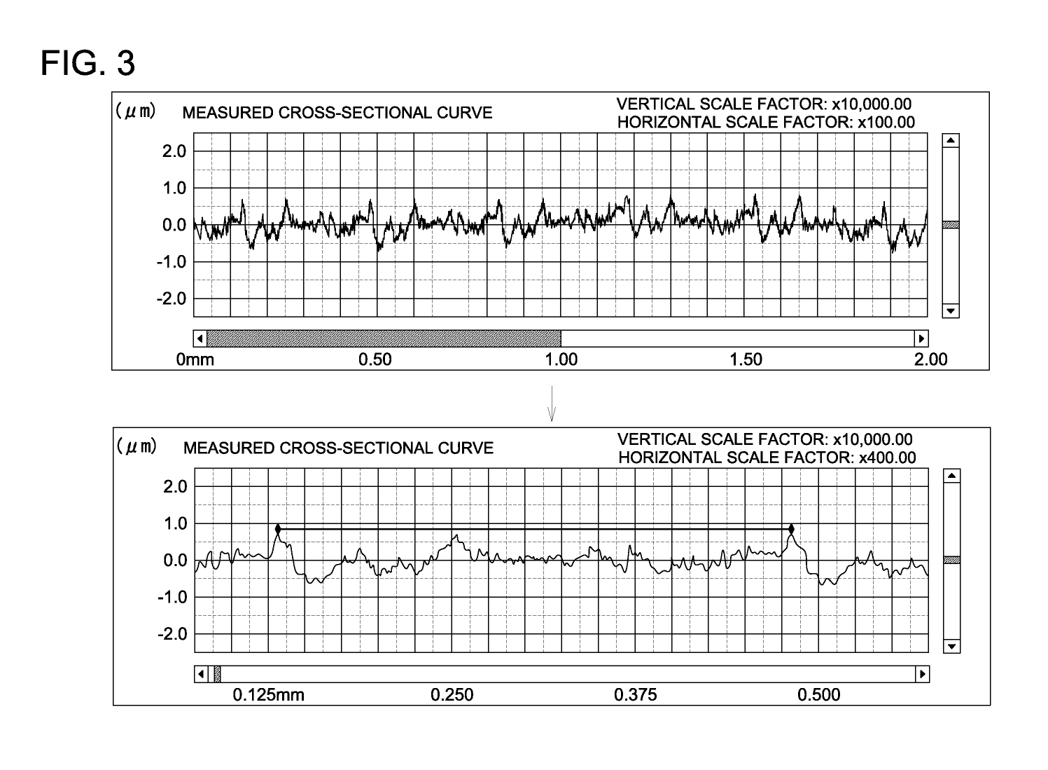

ΔL represents a variation in the processing period width along the central axis direction in the image region of the cylindrical conductive support of the present invention, and can be calculated by reading the processing period width from a cross-sectional curve or a roughness curve of the processing surface, for example, as shown in FIG. 3. That is, the width period is read out by increasing the magnification after marking a repeating profile and a period from a spectrum diagram on the upper side of FIG. 3. For example, in the case of the spectrum diagram on the lower side of FIG. 3, the lateral magnification has been quadrupled with respect to the upper side of FIG. 3.

The location to be measured may be an arbitrary location within the image region of a cylindrical conductive support. The length to be measured on the processing surface may be an arbitrary length as long as the processing period width can be read out, but preferable is a length in which at least 5 processing period widths are readable, and specifically preferable is a length in which at least 10 processing period widths are readable.

As the location to be measured, a location near the center in the axis direction of the cylindrical support, for example, is chosen, and the length to be measured, for example, roughly 4 mm is chosen.

The measurement of a cross-sectional curve or a roughness curve is not specifically limited as long as the processing period width is readable from the curve, but usable are, for example, a stylus surface roughness measuring device and a contact less surface analyzer using such as a laser beam.

As an example employing the stylus surface roughness measuring device, the following conditions may be cited.

Measuring device: SURFCOM 1400D, manufactured by Tokyo Seimitsu Co., Ltd.

Measuring mode: Roughness measurement (JIS'01 Standard)

Length to be measured: 4.0 mm

Cut-off: 0.8 mm (Gaussian)

Measuring speed: 0.3 mm/sec

The difference between the maximum value and the minimum value in plural cutting periods read from a cross-sectional curve or a roughness curve measured in this manner is defined as ΔL.

### [Structure of Organic Photoreceptor]

A general structure of an organic photoreceptor will be described below.

In the present invention, an organic photoreceptor means an electrophotographic photoreceptor having a structure in which at least one function of indispensable charge generation function and charge transport function is provided by an organic compound, and, in many cases, is a photoreceptor containing a commonly known organic charge generating material and/or a commonly known organic charge transport material. The organic photoreceptor means all types of organic photoreceptors including one in which the charge generation function and the charge transport function each are provided by a polymer complex. In the following description, these photoreceptors may be simply referred to as an organic photoreceptor.

The organic photoreceptor of the present invention contains at least a charge generation layer and a charge transport layer, or further a protective layer which are sequentially laminated on a cylindrical conductive support. Concretely, the following layer construction may be exemplified.

(1) A layer structure in which an intermediate layer, a charge generating layer and a charge transport layer as a photosensitive layer, and a protective layer, if necessary, are laminated in that order on a cylindrical conductive support

(2) A layer structure in which an intermediate layer, a single layer containing a charge transport material and a charge generating material as a photosensitive layer, and a protective layer, if necessary, are laminated in that order on a conductive support

The layer structure of the organic photoreceptor of the present invention in relation mainly to the above-described (1) will be described below.

### [Cylindrical Conductive Support]

The cylindrical conductive substrate (also, referred to as a cylindrical conductive support) to be used in the present invention is not specifically limited as far as it is cylindrical and electrically conductive, and includes, for example, a metal drum of such as aluminum, copper, chromium, nickel, zinc or stainless steel, a cylindrically formed plastic drum having thereon a metal foil of such as aluminum or copper, a plastic drum on which, for example, aluminum, indium oxide or tin oxide is vacuum evaporated, a metal coated with an electrically conductive material alone or together with a binder resin to form an electrically conductive layer, and a plastic drum. Material or construction is not specifically limited as far as the structure of the present invention can be formed.

### (Intermediate Layer)

In the present invention, an intermediate layer having a bather function and an adhesion function can be provided between a cylindrical conductive support and a charge generation layer. When considering various failure protections and so forth, a structure in which an intermediate layer is provided is preferable.

The intermediate layer can be formed, for example, via dip coating by dissolving a binder resin such as casein, polyvinyl alcohol, nitrocellulose, an ethylene acrylic acid copolymer, polyamide, polyurethane, or gelatin in a commonly known solvent. Of these, an alcohol-soluble polyamide resin is preferable.

Further, various kinds of particles (for example, metal oxide particles) can be contained for the purpose of for example, adjusting the resistance of the intermediate layer. Examples of such particles include alumina, zinc oxide, titanium oxide, tin oxide, antimony oxide, indium oxide, and bismuth oxide. Also, particles formed of indium oxide doped with tin, tin oxide doped with antimony, or zirconium oxide are usable.

These metal oxides may be used singly or in combination with at least two kinds as a mixture. When at least two kinds are mixed, configuration of solid solution or fusion may be taken. Such a metal oxide preferably has an average particle diameter of 0.3 μm or less, and more preferably has an average particle diameter of 0.1 μm or less. Further, these oxide particles may be subjected to a single surface treatment or plural surface treatments with an inorganic compound or an organic compound.

As a solvent used for an intermediate layer, one which disperses inorganic particles and dissolves a polyamide resin. Specifically, alcohols having 1-4 carbon atoms, such as methanol, ethanol, n-propyl alcohol, isopropyl alcohol, n-butanol, t-butanol and sec-butanol are preferable in view of excellent solubility of polyamide and coatability. Further, in order to improve a storage property and dispersibility of particles, an auxiliary solvent may be used in combination with the foregoing solvent. Examples of the auxiliary solvent capable of obtaining excellent effects include benzyl alcohol, toluene, methylene chloride, cyclohexane and tetrahydrofuran.

The concentration of a binder resin is appropriately selected depending on layer thickness of the intermediate layer and a production speed.

As a mixture ratio of inorganic particles to a binder resin during dispersion of the inorganic particles, 20-400 parts by mass of the inorganic particles with respect to 100 parts by mass of the binder resin are preferable, and 50-200 parts by mass of the inorganic particles with respect to 100 parts by mass of the binder resin are more preferable.

As a means to disperse inorganic particles, for example, an ultrasonic homogenizer, a ball mill, a sand grinder and a homomixer are usable, however, the present invention is not limited thereto.

A method of drying the intermediate layer can be appropriately selected depending on the kind of a solvent, and the layer thickness, but thermal drying is preferable.

The intermediate layer preferably has a layer thickness of 0.1-30 μm, and more preferably has a layer thickness of 0.3-15 μm.

### (Charge Generation Layer)

Charge generation material (CGM) is contained in a charge generation layer. As other substance, a binder resin or other additive may be contained.

A gallium phthalocyanine pigment is used in the charge generation layer of the present invention. When a gallium phthalocyanine pigment is used in the charge generation layer, the variation in sensitivity due to variation in thickness of the charge generation layer become smaller, while exhibiting a high sensitivity, whereby the object of the present invention can be more effectively achieved.

Examples of a gallium phthalocyanine pigment preferably used in the present invention include: a chlorogallium phatalocyanine having specific diffraction peaks at Bragg angles (2θ±0.2°) of at least 7.4°, 16.6°, 25.5° and 28.3° in an X-ray diffraction spectrum using Cu—Kα radiation; a hydroxygallium phatalocyanine having specific diffraction peaks of at least 7.5°, 9.9°, 12.5°, 16.3°, 18.6°, 25.1° and 28.1°; and a gallium phatalocyanine having specific diffraction peaks of at least 6.8°, 12.8°, 15.8° and 26.6°. By employing a charge generation layer containing a gallium phthalocyanine pigment having such X-ray diffraction peaks in combination with a conductive support having aforementioned ΔL property of the present invention, the effect of the present of the invention can be more notably achieved.

In addition to the aforementioned gallium phthalocyanine pigment, a charge generation material (CGM) well-known in the art can be used in combination, if necessary, for example, a phthalocyanine pigment other than the gallium phthalocyanine pigment, an azo pigment, a perylene pigment and an azulenium pigment. However, it is preferable that the charge generation material mainly contains the gallium phthalocyanine pigment, where it is preferable that 50% by mass or more is the gallium phthalocyanine pigment.

When a binder resin is used in the charge generation layer as a dispersant of the CGM, a resin well-known in the art may be used. Examples of a preferable binder include a formal resin, a butyral resin, a silicone resin, silicone modified butyral resin and a phenoxy resin. As the ratio of the binder to the charge generation material, preferable is 20-600 mass parts of a charge generation material in 100 mass parts of a binder. By using such a resin, the residual electric potential after repeated use may be minimized. The thickness of a charge generation layer is preferably 0.01 μm-1 μm.

As to formation of a charge generating layer, it is preferred that a charge generating material is dispersed in a solution in which a binder resin is dissolved in a solvent employing a dispersing apparatus to prepare a coating solution, the coating solution is coated with a coater so as to give a predetermined thickness, and the coating film is dried to prepare the charge generating layer.

Examples of the solvent for coating after dissolving a binder resin, which is used for the charge generating layer, include toluene, xylene, methylene chloride, 1,2-dichloroethane, methyl ethyl ketone, 4-methoxy-4-methyl-2-pentane, cyclohexane, ethyl acetate, butyl acetate, methanol, ethanol, propanol, butanol, methyl cellosolve, ethyl cellosolve, tetrahydrazine, 1-dioxane, 1,3-dioxolane, pyridine and diethyl amine, but the present invention is not limited thereto.

Examples of usable dispersing means for the charge generating material include an ultrasonic homogenizer, a ball mill, a sand grinder, a homogenizing mixer and so forth, but the present invention is not limited thereto.

### (Charge Transport Layer)

A charge transport layer used in a photosensitive layer of the present invention contains a charge transport material (CTM) and a binder resin, and is formed via coating after dissolving the charge transport material in a binder resin solution.

Examples of the charge transport material include a carbazole derivative, an oxazole derivative, an oxacliazole derivative, a thiazole derivative, a thiadizole derivative, a triazole derivative, an imidazole derivative, an imidazolone derivative, an imidazolidine derivative, a bisimidazolidine derivative, a styryl compound, a hydrazone compound, a pyrazoline compound, an oxazolone derivative, a benzoimidazole derivative, a quinazoline derivative, a benzofuran derivative, an acridine derivative, a phenazine derivative, an aminostilbene derivative, a triaryl amine derivative, a phenylene diamine derivative, a stilbene derivative, a benzidine derivative, poly-N-vinyl carbazole, poly-1-vinyl pyrene and poly-9-vinyl anthracene, a triphenyl amine derivative and so forth, and these may be used by mixing at least two kinds.

A commonly known resin can be used as a binder resin for the charge transport layer, and examples thereof include a polycarbonate resin, a polyacrylate resin, a polyester resin, a polystyrene resin, a styrene-acrylnitryl copolymer resin, a polymethacrylic acid ester resin, and a styrene-methacrylic acid ester copolymer resin, but the polycarbonate resin is preferable. Further, BPA, BPZ, dimethyl BPA, and a BPA-dimethyl BPA copolymer are preferable in view of crack resistance, wear resistance, and an electrification property.

As to formation of a charge transport layer, it is preferred that a binder resin and a charge transport material are dissolved to prepare a coating solution; the coating solution is coated with a coater so as to give the predetermined layer thickness; and the coating film is dried to prepare charge transport layer.

Examples of the solvent to dissolve the binder resin and the charge transport material include toluene, xylene, methylene chloride, 1,2-dichloroethane, methyl ethyl ketone, cyclohexane, ethyl acetate, butyl acetate, methanol, ethanol, propanol, butanol, tetrahydrofuran, 1,4-dioxane, 1,3-dioxolane, pyridine and diethyl amine, but the present invention is not limited thereto.

The mixing ratio of the charge transport material to the binder resin is preferably 10-500 parts by mass of the charge transport material with respect to 100 parts by mass of the binder resin, and more preferably 20-100 parts by mass of the charge transport material.

The layer thickness of the charge transport layer differs depending on properties of the charge transport material, properties and a mixing ratio of the binder resin, but it is preferably 5-40 μm, and more preferably 10-30 μm.

An antioxidant, an electronic conductive agent and a stabilizer may be added into the charge transport layer. Antioxidants disclosed in JP-A No. 2000-305291 may be used, and electronic conductive agents disclosed in JP-A No. 50-137543 and JP-A No. 58-76483 may be used.

### (Protective Layer)

A protective layer used in the photoreceptor of the present invention is formed by coating a coating composition prepared by addition of inorganic particles to a binder resin on a charge transport layer. The protective layer preferably may an antioxidant and a lubricant.

There are usable inorganic fine particles such as silica, alumina, strontium titanate, zinc oxide, titanium oxide, tin oxide, antimony oxide, indium oxide, bismuth oxide, tin-doped indium oxide, antimony- or tantalum-doped tin oxide or zirconium oxide. Specifically, preferable are, for example, hydrophobic silica particles of which surfaces are subjected to a hydrophobizing treatment, hydrophobi_{c} alumina particles, hydrophobic zirconia particles, and sintered silica particles.

The number average primary particle size of inorganic particles is preferably from 1 nm-300 nm, and more preferably from 5 nm-100 nm. The number average primary particle size of inorganic particles is a value obtained in such a manner that 300 particles are randomly chosen and observed with a transmission electron microscope at a 10,000-fold magnification and the number average diameter of the Fere diameter is calculated from the observed values.

A binder resin used for a protective layer may employ any one of a thermoplastic resin and a thermosetting resin. Specific examples thereof include a polyvinyl butyral resin, an epoxy resin, a polyurethane resin, a phenol resin, a polyester resin, an alkyd resin, a polycarbonate resin, a silicone resin, and a melamine resin.

Examples of a lubricant material used for a protective layer include resin fine-powder (for example, a fluororesin, a polyolefin resin, a silicone resin, a melamine resin, a urea resin, an acrylic resin, a styrene resin, and the like), metal oxide powder (for example, titanium oxide, aluminum oxide, tin oxide, and the like), a solid lubricant (for example, polytetrafluoroethylene, polychlorotrifluoroethylene, polyfluorovinylidene, zinc stearate, aluminum stearate, and the like), silicone oil (for example, dimethylsilicone oil, methylphenylsilicone oil, methyl hydrogen polysiloxane, cyclic dimethyl polysiloxane, alkyl-modified silicone oil, polyether-modified silicone oil, alcohol-modified silicone oil, fluorine-modified silicone oil, amino-modified silicone oil, mercapto-modified silicone oil, epoxy-modified silicone oil, carboxy-modified silicone oil, higher fatty acid-modified silicone oil, and the like), fluororesin powder (for example, tetrafluoroethylene resin powder, trifluorochloro ethylene resin powder, hexafluoroethylene propylene powder, fluorinated vinyl resin powder, fluorinated vinylidene resin powder, fluoro-di-chloro-ethylene resin powder and copolymers of these), polyolefin resin powder (for example, homo-polymer resin powder such as polyethylene resin powder, polypropylene resin powder and polyhexene resin powder; copolymer resin powder such as ethylene-propylene copolymer and ethylene-butene copolymer; three-dimensional copolymer of these and hexane; and heat-modified polyolefin resin powder).

The molecular weight or the individual resin or its powdery particle size may appropriately be chosen. In the case of a particulate material, its particle size is preferably from 0.1 μm-10 μm. A dispersing agent to allow a lubricant to be homogeneously dispersed may be added to a binder resin.

### (Image Forming Apparatus)

Next, an image forming apparatus employing a photoreceptor of the present invention will be described.

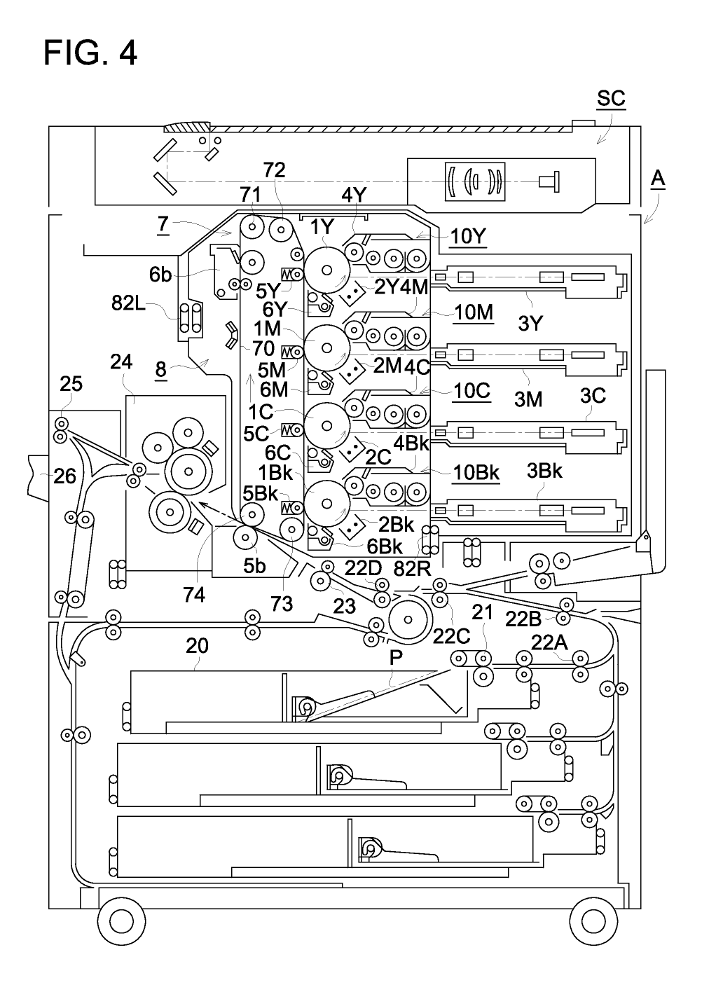

FIG. 4 is a cross-sectional diagram of a color image forming apparatus in an embodiment of the present invention.

In an image forming apparatus of the present invention, when an electrostatic latent image is formed on a photoreceptor, a semiconductor laser or a light-emitting diode having an oscillation wavelength of 350-850 nm is used as an image exposure light source. Using such an image exposure light source, a light exposure dot diameter in the primary scanning direction of writing is narrowed to 10-100 μm, and digital light exposure is conducted on an organic photoreceptor to obtain an electrophotographic image at a high resolution of from 600 dpi-2400 dpi or more (dpi: the number of dots per 2.54 cm).

The light exposure dot diameter is a length of exposing beam (Ld: which is determined at the maximum length) along the primary scanning direction of an area having exposing intensity of more than 1/e² times of the peak intensity of the exposing light beam.

The light beam to be used includes the beams of the scanning optical system using the semiconductor laser, solid scanner such as an LED and so forth. The distribution of the light intensity includes Gauss distribution and Lorenz distribution. The diameter of an area having light intensity exceeding 1/e² times of the peak intensity is designated as a light exposure dot diameter of the present invention.

This color image forming apparatus is called as a tandem type color image forming apparatus, and comprises four sets of image forming sections (image forming units) 10Y, 10M, 10C, and 10Bk, endless belt shaped intermediate transfer member unit 7, sheet feeding and conveyance device 21, and fixing device 24. The original document reading apparatus SC is placed on top of main unit A of the image forming apparatus.

Image forming section 10Y that forms images of yellow color comprises charging device 2Y, light exposure device 3Y, developing device 4Y, primary transfer roller 5Y as a primary transfer section, and cleaning device 6Y all placed around drum-formed photoreceptor 1Y which acts as the first image supporting body. Image forming section 10M that forms images of magenta color comprises drum-formed photoreceptor 1M which acts as the first image supporting body, charging device 2M, light exposure device 3M, developing device 4M, primary transfer roller 5M as a primary transfer section, and cleaning device 6M. Image forming section 10C that forms images of cyan color comprises drum-formed photoreceptor 1C which acts as the first image supporting body, charging device 2C, light exposure device 3C, developing device 4C, primary transfer roller 5C as a primary transfer section, and cleaning device 6C. Image forming section 10Bk that forms images ofblack color comprises drum-formed photoreceptor 1Bk which acts as the first image supporting body, charging device 2Bk, light exposure device 3Bk, developing device 4Bk, primary transfer roller 5Bk as a primary transfer section, and cleaning device 6Bk.

Four sets of image forming units 10Y, 10M, 10C, and 10Bk are constituted, centering on photoreceptor drums 1Y, 1M, 1C, and 1Bk, by rotating charging devices 2Y, 2M, 2C, and 2Bk, image wise light exposure devices 3Y, 3M, 3C, and 3Bk, rotating developing devices 4Y, 4M, 4C, and 4Bk, and cleaning devices 5Y, 5M, 5C, and 5Bk that clean photoreceptor drums 1Y, 1M, 1C, and 1Bk.

Image forming units 10Y, 10M, 10C, and 10Bk, all have the same configuration excepting that the color of the toner image forme in each unit is different on respective photoreceptor drums 1Y, 1M, 1C, and 1Bk, and detailed description is given below taking the example of image forming unit 10Y.

Image forming unit 10Y has, placed around photoreceptor drum 1Y which is the image forming body, charging device 2Y (hereinafter referred to merely as charging unit 2Y or charger 2Y), light exposure device 3Y, developing device 4Y, and cleaning device 5Y (hereinafter referred to simply as cleaning device 5Y or as cleaning blade 5Y), and forms yellow (Y) colored toner image on photoreceptor drum 1Y. Further, in the present preferred embodiment, at least photoreceptor drum 1Y, charging device 2Y, developing device 4Y, and cleaning device 5Y in image forming unit 10Y are provided in an integral manner.

Charging device 2Y is a device that applies a uniform electrostatic potential to photoreceptor drum 1Y, and corona discharge type charger 2Y is being used for photoreceptor drum 1Y in the present preferred embodiment.

Imagewise light exposure device 3Y is a device that conducts light exposure, based on an image signal (Yellow), and forms an electrostatic latent image corresponding to the yellow color image on 1Y provided with a uniform electric potential by charging device 2Y. This light exposure device 3Y is one composed of LED arranged in the form of an array in the axis direction of photoreceptor drum 1Y, and an image focusing element, or is a laser optical system.

The image forming apparatus of the present invention may be configured in such a way that the constituents such as the foregoing photoreceptor, a developing device, a cleaning device and so forth are integrally combined to a process cartridge (image forming unit), and this image forming unit may be installed in the apparatus main body as a detachable unit. It is also possible to arrange such a configuration that at least one of the charging device, the imagewise light exposure device, the developing device, the transfer or separation device and the cleaning device is integrally supported with the photoreceptor to form a process cartridge (image forming unit) as a single detachable image forming unit, employing a guide device such as a rail of the apparatus main body.

Intermediate transfer member unit 7 in the form of an endless belt is wound around a plurality of rollers, and has endless belt shaped intermediate transfer member 70 which acts as a second image carrier in the shape of a semiconducting endless belt which is supported in a free manner to rotate.

The images of different colors formed by image forming units 10Y, 10M, 10C, and 10Bk, are successively transferred on to rotating endless belt shaped intermediate transfer member 70 by primary transfer rollers 5Y, 5M, 5C, and 5Bk acting as the primary image transfer section, thereby forming the synthesized color image. Transfer material P as the transfer material stored inside sheet feeding cassette 20 (the supporting body that carries the final fixed image: for example, plain paper, transparent sheet, etc.,) is fed from sheet feeding device 21, pass through a plurality of intermediate rollers 22A, 22B, 22C, and 22D, and resist roller 23, and is transported to secondary transfer roller 5b which functions as the secondary image transfer section, and the color image is transferred in one operation of secondary image transfer on to transfer material P. Transfer material P on which the color image has been transferred is subjected to fixing process by fixing device 24, and is gripped by sheet discharge rollers 25 and placed above sheet discharge tray 26 outside the equipment. Here, the transfer supporting body of the toner image formed on the photoreceptor of the intermediate transfer body or of the transfer material, etc. is collectively called a transfer medium.

On the other hand, after the color image is transferred to transfer material P by secondary transfer roller 5b functioning as the secondary transfer section, endless belt shaped intermediate transfer member 70 from which transfer material P has been separated due to different radii of curvature is cleaned by cleaning device 6b to remove the remaining toner.

During image formation processing, primary transfer roller 5Bk is at all times contacting against photoreceptor 1Bk. Other primary transfer rollers 5Y, 5M, and 5C come into contact with photoreceptors 1Y, 1M, and 1C, respectively, only during color image formation.

Secondary transfer roller 5b comes into contact with endless belt shaped intermediate transfer body 70 only when secondary transfer is conducted with transfer material P passing through this.

Further, chassis 8 can be pulled out via supporting rails 82L and 82R from body A of the apparatus.

Chassis 8 possesses image forming sections 10Y, 10M, 10C, and 10Bk, and endless belt shaped intermediate transfer member unit 7.

Image forming sections 10Y, 10M, 10C, and 10Bk are arranged in column in the vertical direction. Endless belt shaped intermediate transfer member unit 7 is placed to the left side in the figure of photoreceptor drums 1Y, 1M, 1C, and 1Bk. Endless belt shaped intermediate transfer member unit 70 possesses endless belt shaped intermediate transfer member 70 that can rotate around rollers 71, 72, 73, and 74, primary image transfer rollers 5Y, 5M, 5C, and 5Bk, and cleaning device 6b.

The image forming apparatus of the present invention is commonly suitable for electrophotographic apparatuses such as electrophotographic copiers, laser printers, LED printers, liquid crystal shutter type printers and so forth. Further, the image forming apparatus can be widely utilized for apparatuses for displaying, recording, light printing, plate making and facsimile to which an electrophotographic technique is applied.

### EXAMPLES

Next, typical embodiments of the present invention are presented to further describe the present invention, but the aspects of the present invention are not limited thereto.

In the following description, “part” or “parts” represents “part by mass” or “parts by mass”, respectively.

### Example 1

### <Preparation of Photoreceptor 1>

### <Preparation of Support 1>

An aluminum alloy crude cylinder having a length of 362 mm was set onto a CNC lathe, and subjected to cutting with a diamond sintered tool bit while setting up the following cutting program so as to give a cylindrical Support 1 having an outer radius of 59.95 mm, and a surface roughness Rz of 0.75

The rotation speed of the main shaft was 3000 rpm. With respect to the tool bit moving speed, starting from the moving speed of 0.300 mm/rev, the moving speeds of 0.300 mm/rev and 0.315 mm/rev were alternately applied to the 6 continuous sections having sectional lengths of; sequentially, 0.5 mm, 1.6 mm, 2.8 mm, 1.1 mm, 2.5 mm and 3.2 mm. The tool bit moving speed was switched at the end of each section. One period of the operation including the above mentioned 6 sections was repeated. Resulting ΔL of the obtained crude cylinder was 50 μm.

The ΔL measurement was conducted around the center of the crude cylinder according to JIS'01 Standard for roughness measurement with a measured length of 4.0 mm, a cut-off of 0.8 mm (Gaussian) and a measuring speed of 0.3 mm/sec, employing SURFCOM 1400D produced by TOKYO SEIMITSU Co., Ltd. The difference between the maximum value and the minimum value in cutting period read from the resulting cross-sectional curve was designated as the ΔL value.

### (Formation of Intermediate Layer)

After one part by mass of binder resin (N−1) was added into 20 parts by mass of ethanol/n-propylalcohol/tetrahydrofuran (45:20:30 in volume ratio) followed by dissolving while stirring, 4.2 parts by mass of rutile type titanate oxide particles (an average primary particle diameter of 35 nm) having been subjected to a surface treatment with 5% by mass of methylhydrogen polysiloxane were mixed to disperse the particles employing a bead mill. In this case, dispersing was carried out employing zirconia beads having an average particle diameter of 0.3 mm, a filling ratio of 80%, a peripheral speed of 4 msec, and a mill residence time of 3 hours to prepare an intermediate layer coating liquid. After filtering this liquid with a polypropylene filter element having a filtration accuracy of 5 μm, the intermediate layer coating liquid was applied onto the outer circumference of “Support 1” prepared above by an immersion coating method after washing, to form an “intermediate layer” having a dry thickness of 2 μm.

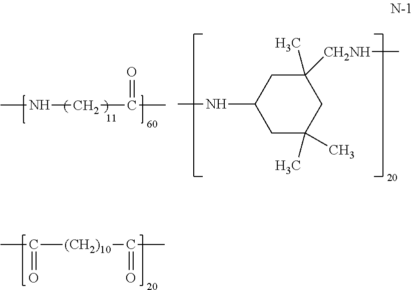

### (Formation of Charge Generating Layer)

The following components were mixed and dispersed employing a sand mill homegenizer to prepare a charge generating layer coating liquid. This coating liquid was applied on the intermediate layer by an immersion coating method to form “charge generating layer” having a dry thickness of 0.3 μm.

| | |
|---|---|
| Gallium phthalocyanine pigment (hydroxygallium | 20 parts by mass |
| phthalocyanine pigment having specific diffraction | |
| peaks at Bragg angles (2θ ± 0.2°) of at least | |
| 7.5°, 9.9°, 12.5°, 16.3°, 18.6°, 25.1°, and 28.1° | |
| in an X-ray diffraction spectrum using Cu-Kα | |
| radiation} | |
| Polyvinyl butyral (BX-1, produced by | 10 parts by mass |
| Sekisui Chemical Co., Ltd.) | |
| Methylethyl ketone | 700 parts by mass |
| Cyclohexanone | 300 parts by mass |

### (Formation of Charge Transport Layer)

The following components were mixed and dissolved to prepare a charge transport layer coating liquid. This solution was applied on the foregoing charge generating layer by an immersion coating method, followed by drying at 120° for 70 minutes to form a charge transport layer having a dry thickness of 20 μm. Thus, Photoreceptor 1 was prepared.

| | |
|---|---|
| Charge transport material (the following CTM-A) | 50 parts by mass |
| Polycarbonate resin “IUPILON-Z300” | 100 parts by mass |
| (produced by Mitsubishi Gas Chemical Company Inc.) | |
| Antioxidant (2,6-di-t-butyl-4-methylphenol) | 8 parts by mass |
| Tetrahydrofuran/toluene (8/2 in volume ratio) | 750 parts by mass |

CTM-A 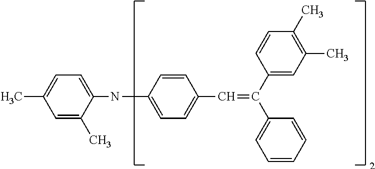
CTM-B 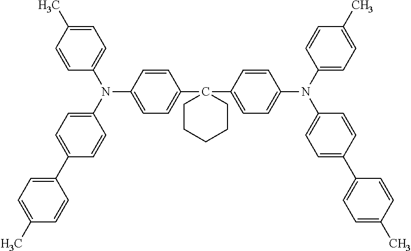
CTM-C 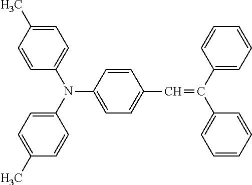
CTM-D

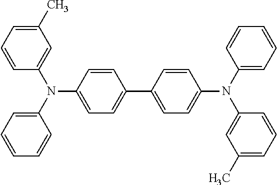

### <Preparation of Photoreceptor 2>

Photoreceptor 2 was prepared in the same manner as described in the preparation of Photoreceptor 1 except that the rotation speed of the main shaft was changed to 2000 rpm to obtain a crude cylinder having a ΔL value of 30 μm (Support 2).

### <Preparation of Photoreceptor 3>

Photoreceptor 3 was prepared in the same manner as described in the preparation of Photoreceptor 1 except that the rotation speed of the main shaft was changed to 750 rpm to obtain a crude cylinder having a ΔL value of 10 μm (Support 3).

### <Preparation of Photoreceptor 4>

Photoreceptor 4 was prepared in the same manner as described in the preparation of Photoreceptor 1 except that the rotation speed of the main shaft was changed to 7000 rpm to obtain a crude cylinder having a ΔL value of 70 μm (Support 4).

### <Preparation of Photoreceptor 5>

Photoreceptor 5 was prepared in the same manner as described in the preparation of Photoreceptor 1 except that the rotation speed of the main shaft was changed to 6000 rpm to obtain a crude cylinder having a ΔL value of 60 μm (Support 5).

### <Preparation of Photoreceptor 6>

Photoreceptor 6 was prepared in the same manner as described in the preparation of Photoreceptor 1 except that the rotation speed of the main shaft was changed to 10000 rpm to obtain a crude cylinder having a ΔL value of 100 μm (Support 6).

### <Preparation of Photoreceptor 7>

Photoreceptor 7 was prepared in the same manner as described in the preparation of Photoreceptor 1 except that the moving speeds of the tool bit of 0.350 and 0.352 mm/rev were alternatively applied to the 6 sections each having an interval of 0.5 mm to obtain a crude cylinder having a ΔL value of 7 μm (Support 7).

### <Preparation of Photoreceptor 8>

Photoreceptor 8 was prepared in the same manner as described in the preparation of Photoreceptor 1 except that the moving speeds of the tool bit of 0.300 and 0.315 mm/rev were changed to 0.350 and 0.380 mm/rev and alternatively applied to the 6 sections each having an interval of 1.5 mm, wherein the 6 intervals were alternately increased and decreased by 0.005 mm in turn at every section, to obtain a crude cylinder having a ΔL value of 7 μm (Support 8).

### <Preparation of Photoreceptors 9-11>

Photoreceptors 9-11 were prepared in the same manner as described in the preparation of Photoreceptor 1 except that the charge transport material CTM-A in the charge transport layer was changed to CTM-B, CTM-C and CTM-D, respectively.

### <Preparation of Photoreceptor 12>

Photoreceptor 12 was prepared in the same manner as described in the preparation of Photoreceptor 1 except that the gallium phthalocyanine pigment in the charge generation layer was changed toY-titanyl phthalocyanine {a titanyl phthalocyanine pigment having a maximum diffraction peak at a Bragg angle (2θ±0.2°) of 27.3° in an X-ray diffraction spectrum with Cu—Kα radiation}.

### <Preparation of Photoreceptor 13>

Photoreceptor 13 was prepared in the same manner as described in the preparation of Photoreceptor 1 except that the moving speed of the tool bit was fixed at 0.350 mm/rev to obtain a crude cylinder having a ΔL value of 3 pin (Support 9).

The above Photoreceptors 1-13 were summarized in Table 1.

TABLE 1

| Photoreceptor | Support | ΔL | Charge generating | Charge transporting |
|---|---|---|---|---|
| No. | No. | (μm) | material | material |
| 1 | 1 | 50 | *1 | CTM-A |
| 2 | 2 | 30 | *1 | CTM-A |
| 3 | 3 | 10 | *1 | CTM-A |
| 4 | 4 | 70 | *1 | CTM-A |
| 5 | 5 | 60 | *1 | CTM-A |
| 6 | 6 | 100 | *1 | CTM-A |
| 7 | 7 | 7 | *1 | CTM-A |
| 8 | 8 | 200 | *1 | CTM-A |
| 9 | 1 | 50 | *1 | CTM-B |
| 10 | 1 | 50 | *1 | CTM-C |
| 11 | 1 | 50 | *1 | CTM-D |
| 12 | 1 | 50 | *2 | CTM-A |
| 13 | 9 | 3 | *1 | CTM-A |

In Table 1, *1 and *2 each represent a charge generation material. *1 represents gallium phthalocyanine pigment (hydroxygallium phthalocyanine pigment having specific diffraction peaks at Bragg angles (2θ ± 0.2°) of 7.5°, 9.9°, 12.5°, 16.3°, 18.6°, 25.1°, and 28.1°in an X-ray diffraction spectrum using Cu-Kα radiation} and *2 represents Y-titanyl phthalocyanine {a titanyl phthalocyanine pigment having a maximum diffraction peak at a Bragg angle (2θ ± 0.2°) of 27.3° in an X-ray diffraction spectrum with Cu-Kα radiation}.

### (Performance Evaluation)

### (Diagonal Streaks Caused by Interference)

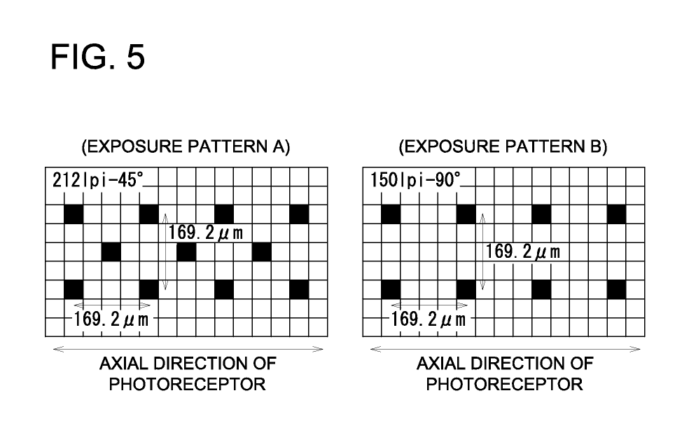

For performance evaluations, utilized was the black (Bk) position of bizhub PRO C6501 manufactured by Konica Minolta Business Technologies, Inc., shown in FIG. 4, to visually evaluate “EXPOSURE PATTERN A (at various densities) and EXPOSURE PATTERN B (at various densities)” both shown in FIG. 5, and a halftone image which was output under a low temperature-low humidity condition (10° C. and 20% RH) using “POD GLOSS COAT (100 g/m²)” produced by Oji Paper Co., Ltd.

Results obtained via evaluation based on the following criteria are shown in Table 2.

A: No diagonal streak is observed at all.

B: Diagonal streaks are slightly observed, but there appears no practical problem.

C: Diagonal streaks are observed, and there appears a practical problem.

### (Gradation)

Under the above low temperature-low humidity condition (10° C. and 20% RH), an original image having 60 gradation steps from a white image to a solid black image was copied to evaluate gradation. Evaluation was carried out by visually observing the obtained image having gradation steps under sufficient daylight to determine total number of significant gradation steps. Evaluation was

A: Gradation steps were 21 or more (Good)

B: Gradation steps were 12-20 (No problem was caused in practical use.)

C: Gradation steps were 8-11 (Consideration on the practical use was necessary: practically usable for such an image that gradation is not specifically important

D: Gradation steps were less than 7 (A problem was caused in practical use.)

### (Black Spots)

After printing 200,000 sheets of A4 sized neutralized paper on which images of Y, M, C and Bk each of which having a coverage rate of 2.5% were formed at 20° C. and 50% RH, 10,000 sheets of the same images of A4 size were continuously formed under a high temperature-high humidity condition (HH: 35° C. and 85% RH), while setting the grid charge voltage of a scorotron charger at −1000 V and the bias voltage of the reversal development at −800 V. The presence (or non presence) of an image defect due to black spots on the starting image and the final image were examined

A: No black spot defect was observed

B: Black spots were slightly observed in the final image (6 spots or less in an A4 sized paper sheet), however, the image was practically usable.

C: Black spots were observed in the starting image, and further increased in the final image.

### (Two-Dot Line)

A white two-dot line was formed in a black solid background and evaluated according to the following criteria.

A: The two-dot line was continuously reproduced and the density of the black solid image was 1.2 or more. (Good)

B: The two-dot line was r continuously reproduced but the density of the black solid image was less than 1.2 and not less than 1.0. (No problem was caused in practical use.)

C: The two-dot line was brokenly reproduced or the density of the black solid image was less than 1.0 even when the two-dot line was continuously reproduced (A problem was caused in practical use.)

The above image density was measured by Macbeth RD-918, manufactured by Macbeth and represented by the relative reflective density when the reflective density of the paper was set at zero.

TABLE 2

| Photo- | *3 | | | | | |
|---|---|---|---|---|---|---|
| receptor | Exposure | Exposure | Grada- | Black | two-dot | |
| No. | pattern A | pattern B | tion | spots | line | Remarks |
| 1 | A | A | A | A | A | Inventive |
| 2 | A | A | A | A | A | Inventive |
| 3 | A | B | A | A | B | Inventive |
| 4 | A | A | A | A | A | Inventive |
| 5 | A | A | B | A | B | Inventive |
| 6 | A | B | A | B | A | Inventive |
| 7 | C | C | A | A | B | Comparative |
| 8 | B | B | B | B | B | Inventive |
| 9 | A | A | B | A | B | Inventive |
| 10 | A | B | B | A | B | Inventive |
| 11 | A | B | B | A | B | Inventive |
| 12 | A | B | A | C | B | Comparative |
| 13 | C | C | A | A | B | Comparative |

In Table 2, *3 represents diagonal streaks caused by interference.

As is clear from the evaluation results shown in above Table 2, Photoreceptors 1-6 and 8-11 each of which utilized gallium phthalocyanine in the charge generation layer and met the condition of ΔL of 10 μm or more showed excellent effects of more than practical levels. On the other hand, Photoreceptor 7 of which ΔL was 7 μm, Photoreceptor 12 which utilized Y-titanyl phthalocyanine as the charge generating material and Photoreceptor 13 of which ΔL was 3 μm each received evaluation of practically problematic.

### <Preparation of Photoreceptors 21-26 and 28-31>

Photoreceptors 21-26 and 28-31 corresponding to Photoreceptors 1-6 and 8-11, respectively, were prepared in the same manner as the preparation of Photoreceptors 1-6 and 8-11 except that the gallium phthalocyanine pigment of these photoreceptors were changed from hydroxygallium phthalocyanine having characteristic X-ray diffraction peaks at 7.5°, 9.9°, 12.5°, 16.3°, 18.6°, 25.1°, and 28.1°, to chlorogallium phthalocyanine having characteristic X-ray diffraction peaks at 7.4°, 16.6°, 25.5° and 28.3°.

When these Photoreceptors 21-26 and 28-31 were evaluated in the same manner as the evaluation of Photoreceptor 1, almost the same excellent results as those of Photoreceptors 21-26 and 28-31 were obtained.

What is claimed is:

1. An organic photoreceptor comprising a cylindrical support having thereon at least a charge generation layer and a charge transport layer, the cylindrical support having a corrugation processing profile along a central axis direction of the cylindrical support provided on a circumferential surface of the cylindrical support,
wherein
the corrugation processing profile meets Formula 1:
10 μm≦ΔL, Formula 1
provided that ΔL represents a maximum value of variation of periods of the corrugation processing profile within an image-forming region of the cylindrical support, and
the charge generation layer comprises a gallium phthalocyanine pigment.

2. The organic photoreceptor of claim 1, wherein the gallium phthalocyanine pigment is a chlorogallium phatalocyanine having specific diffraction peaks at Bragg angles (2θ±0.2°) of at least 7.4°, 16.6°, 25.5° and 28.3° in an X-ray diffraction spectrum using Cu—Kα radiation.

3. The organic photoreceptor of claim 1, wherein the gallium phthalocyanine pigment is a hydroxygallium phatalocyanine having specific diffraction peaks at Bragg angles (2θ±0.2) of at least 7.5°, 9.9°, 12.5°, 16.3°, 18.6°, 25.1° and 28.1° in an X-ray diffraction spectrum using Cu—Kα radiation.

4. The organic photoreceptor of claim 1 having an intermediate layer between the cylindrical support and the charge generation layer.

5. The organic photoreceptor of claim 5, wherein the intermediate layer comprises particles.

6. The organic photoreceptor of claim 1, wherein the corrugation processing profile meets
10 μm≦ΔL≦200 μm.

7. The organic photoreceptor of claim 1, wherein the corrugation processing profile meets
10 μm≦ΔL≦100 μm.

8. An image forming apparatus comprising:
the organic photoreceptor of claim 1;
a device to form a latent image on the organic photoreceptor;
a device to develop the latent image with a toner;
a device to transfer a toner image formed on the organic photoreceptor to an image support; and
a device to fix the toner image after transferred.
